(19) United States
(12) Patent Application Publication
(10) Pub. No.: US 2025/0289172 A1
(43) Pub. Date: Sep. 18, 2025

(54) CLOSURE NOZZLE FOR A FORMING MACHINE

(71) Applicant: ENGEL AUSTRIA GmbH, Schwertberg (AT)

(72) Inventors: Guenther KLAMMER, Aschbach Markt (AT); Raphael FISCHER, Perg (AT); Richard HARTLAUER, Ernsthofen (AT); Michael SCHMID, St. Valentin (AT); Johannes SCHEUCHENSTUHL, Ried in der Riedmark (AT); Andreas BLUTMAGER, Zagersdorf (AT)

(21) Appl. No.: 19/076,364

(22) Filed: Mar. 11, 2025

(30) Foreign Application Priority Data
Mar. 13, 2024 (AT) A 50215/2024

(51) Int. Cl. B29C 45/23; F16K 5/04

(52) U.S. Cl. CPC B29C 45/23; F16K 5/04

(57) ABSTRACT

A shut-off nozzle for a molding machine, comprising a fluid housing having at least one fluid channel, wherein the at least one fluid channel is designed to guide a-preferably liquid and/or plastic-fluid and a valve element which is mounted rotationally about an axis of rotation relative to the fluid housing and which passes through the fluid channel and has at least one through-opening for the passage of the fluid, wherein a flow cross-section between the fluid channel and the through-opening can be varied by a rotational movement of the valve element and thus a flow rate of the fluid can be influenced, wherein the valve element is mounted in the valve housing in a floating manner along the axis of rotation.

The present invention relates to a shut-off nozzle for a molding machine having the features of the preamble of claim 1, as well as to a molding machine and/or an injection unit for a molding machine comprising such a shut-off nozzle.

Molding machines can include injection molding machines, injection presses, presses and the like. Molding machines in which the plasticized mass is fed into an open mold are also quite conceivable.

In the following, the prior art shall be outlined in the case of an injection molding machine. This analogously applies generally to molding machines.

Generic shut-off nozzles for injection molding machines comprise:
a fluid housing having at least one fluid channel, wherein the at least one fluid channel is designed to guide a, preferably liquid and/or plastic, fluid and
a valve element which is mounted rotationally about an axis of rotation relative to the fluid housing and which passes through the fluid channel and has at least one through-opening for the passage of the fluid, wherein a flow cross-section between the fluid channel and the through-opening can be varied by a rotational movement of the valve element and thus a flow rate of the fluid can be influenced.

An illustrative exemplary embodiment, which is known from the prior art, is disclosed in CA 2687054 A1.

In corresponding embodiments of the prior art, the valve element is rotationally mounted on the valve housing.

With respect to an axial displacement, in known embodiments the valve element is supported relative to the valve housing by a shoulder or the like, so that an axial position of the valve element relative to the valve housing can be ensured and an axial movement can be prevented.

However, due to this axial support of the valve element relative to the valve housing, the valve element is subject to rubbing due to the rotational movement.

This friction of the valve element or of the axial restriction of the valve element relative to the valve housing causes wear during operation, as a result of which the valve element is displaced relative to the valve housing.

This displacement of the valve element relative to the valve housing is due to the abrasion, which displacement leads to an inaccurate positioning of the valve element relative to the valve housing.

This axial displacement or offset of the valve element relative to the valve housing results in a through-opening of the valve element no longer being aligned with a fluid channel of the valve housing.

However, it is necessary for a smooth operation of the shut-off nozzle that, in an open position of the shut-off nozzle, the through-opening of the valve element is aligned as precisely as possible with the fluid channel of the valve housing, so that no shoulders, edges or other flow-influencing geometries arise which influence the flow of the fluid through the shut-off nozzle.

The formation of such flow-influencing geometries, such as, for example, those due to edges or corners, leads to turbulent flows, which furthermore influence the injection molding process and a filling of the mold cavity.

Furthermore, the turbulent flow, for example at edges or corners, additionally introduces thermal energy of the fluid (usually of a plasticized plastic) into the valve housing or the valve element of the shut-off nozzle.

This additionally introduced thermal energy makes it necessary to cool the shut-off nozzle additionally, since otherwise the functioning of the shut-off nozzle could be impaired due to a strong heating of the shut-off nozzle (for example by an uncontrolled thermal expansion of the components, which could lead to a jamming of the components with one another or to damage to the seals).

A further disadvantage of an uncontrolled displacement of the valve element relative to the valve housing is that the flow cross-section could be reduced in an uncontrolled manner.

It is therefore an object of the present invention to provide a shut-off nozzle by means of which the previously described disadvantages of the prior art can be at least partially improved and/or which represents a shut-off nozzle which is more resistant to wear and/or permits a longer service life compared with the embodiment variants of the prior art.

This object is achieved by a shut-off nozzle for a molding machine having the features of claim 1, as well as to a molding machine and/or an injection unit comprising such a shut-off nozzle.

According to the invention, it is provided that a shut-off nozzle for a molding machine comprises:
a fluid housing having at least one fluid channel, wherein the at least one fluid channel is designed to guide a—preferably liquid and/or plastic—fluid and
a valve element which is mounted rotationally about an axis of rotation relative to the fluid housing and which passes through the fluid channel and has at least one through-opening for the passage of the fluid, wherein a flow cross-section between the fluid channel and the through-opening can be varied by a rotational movement of the valve element and thus a flow rate of the fluid can be influenced,
wherein the valve element is mounted in the valve housing in a floating manner along the axis of rotation.

By providing a floating mounting, the valve element is allowed an axial movement along the axis of rotation relative to the valve housing, so that the valve element can align itself with the fluid channel of the valve housing with the through-opening by the flow of the fluid through the shut-off nozzle.

In other words, the flow of the fluid through the shut-off nozzle automatically aligns the valve element with the through-opening with respect to the fluid channel.

This possibility of aligning the valve element with respect to the valve housing is made possible by a controlled, floating mounting.

In other words, an optimal alignment can be caused by a floating mounting, which alignment is adjusted solely by the existing flow through the shut-off nozzle.

This alignment of the valve element with respect to the valve housing as a result of the floating mountains is maintained also during the running operation of the shut-off nozzle and is not affected or is only minimally affected by wear, as a result of which turbulent flows, additional heating or other negative aspects due to an offset of the valve element with respect to the valve housing do not occur during operation.

The fact that by influencing the cross-sectional area of the fluid channel, a flow rate of the fluid can be influenced, can be understood according to the invention in that the fluid channel can be completely closed in a closed position of the shut-off nozzle, so that substantially no flow of the fluid is possible.

In certain embodiments, it can be provided alternatively or additionally that degrees of intermediate opening can be realized, for example in order to control or regulate the volumetric flow through the shut-off nozzle.

The shut-off nozzle is preferably designed to guide a plastic or liquid fluid. Optionally, the fluid can have a gas component, for example in foam injection molding.

Molding machines can include injection molding machines, injection presses, extruders, presses and the like. Molding machines in which the plasticized mass is fed into an open mold are also quite conceivable.

An embodiment of a shut-off nozzle according to the invention can also be used in known embodiments of the prior art (as described in the introduction to the description) and/or can be retrofitted, for example, in such embodiments.

Advantageous embodiments are defined by the dependent claims.

It can be provided that the valve element is arranged in a recess, preferably a bore, which passes through the valve housing.

It is preferably provided that the valve element is preloaded relative to the valve housing by means of at least one spring element, in particular at least one disk spring.

It can be provided that the valve element is preloaded at both ends of the recess passing through the valve housing by means of at least one spring element, preferably at least one disk spring.

It can be provided that the valve element is sealed off from the valve housing by means of at least one sealing element, preferably at least one sealing ring.

Preferably, it can be provided that the valve element is connected in a rotational locked moving manner to an actuating element, which actuating element is designed to rotate the valve element via a rotational movement between a closed position and an open position.

Preferably, it can be provided that the actuating element is designed as a fork element which is connected on both sides to the valve element passing through the valve housing in a rotational locked moving manner.

It can be provided that the valve element is mounted with a play of 0.01 mm to 5 mm—preferably 0.03 mm to 2.5 mm, particularly preferably 0.05 mm to 1 mm—relative to the valve housing and/or relative to a bearing element of the valve housing along the axis of rotation.

It is preferably provided that the valve element is rotationally symmetrical, particularly preferably in the form of a bolt.

It can be provided that the at least one through-opening has a cross-section in a plane orthogonal to its longitudinal extension through the valve element, which cross-section has a larger dimension along the axis of rotation of the valve element than perpendicular thereto.

It may be provided that the at least one through-opening is designed as an elongated hole in cross-section in the plane orthogonal to the longitudinal extent of the at least one through-opening.

It can preferably be provided that the ratio between a dimension of the at least one through-opening in cross-section in the plane orthogonal to the longitudinal extent of the at least one through-opening along the axis of rotation and a height dimension perpendicular thereto is at least of 1.5:1, particularly preferably 2:1.

It can be provided that the value of the dimension of the at least one through-opening along the axis of rotation in cross-section in a plane orthogonal to the longitudinal extent of the at least one through-opening lies in a range of +/−20%, preferably +/−10%, particularly preferably +/−5%, of a diameter of the valve element in the region of the at least one through-opening. It can preferably be provided that the dimension of the at least one through-opening along the axis of rotation in cross-section in the plane orthogonal to the longitudinal extent of the at least one through-opening is equal to the diameter of the valve element in the region of the at least one through-opening.

It can preferably be provided that the at least one fluid channel of the valve housing has, in the flow direction of the fluid,
at an inlet point of the at least one fluid channel into the at least one through-opening of the valve element, and/or
at an outlet point of the at least one through-opening of the valve element into the at least one fluid channel,
the same cross-sectional shape as the at least one through-opening, so that no steps, edges, corners or cross-sectional jumps occur along the flow direction of the fluid in an open position through the shut-off nozzle for the fluid.

Preferably, it can be provided that the at least one fluid channel merges, preferably continuously, into a circular cross-section along its longitudinal extent before the inlet point into the at least one through-opening and/or after the outlet point from the at least one through-opening.

Since the fluid channel before and after the valve element changes into a circular cross section, it can be advantageously provided that, despite the presence of an exemplary embodiment according to the invention, the advantages of a circular connection point of the shut-off nozzle to a molding tool and/or a plasticizing and/or injection unit of a molding machine are nevertheless utilized.

Preferably, it can be provided that the at least one fluid channel and/or the at least one through-opening have particularly preferably a same value of a cross-sectional area along their longitudinal extension, so that no variations of the pressure and/or the flow speed of the fluid result due to cross-sectional changes along the flow direction of the fluid through the shut-off nozzle in an open position of the valve element.

Protection is also sought for a molding machine and/or an injection unit for a molding machine with a shut-off nozzle according to the invention.

Preferably, it can be provided that the injection unit has an injection screw arranged rotationally about its longitudinal axis and displaceable along its longitudinal axis in a barrel.

This injection screw can be designed to plasticize a material to be plasticized by a rotational movement about the longitudinal axis and to push the plasticized material (or the plasticized fluid) out of the barrel by a longitudinal movement along the longitudinal axis, preferably via a shut-off nozzle according to the invention which adjoins the barrel.

Further advantages and details of the invention are apparent from the figures and the associated description of the figures. In particular

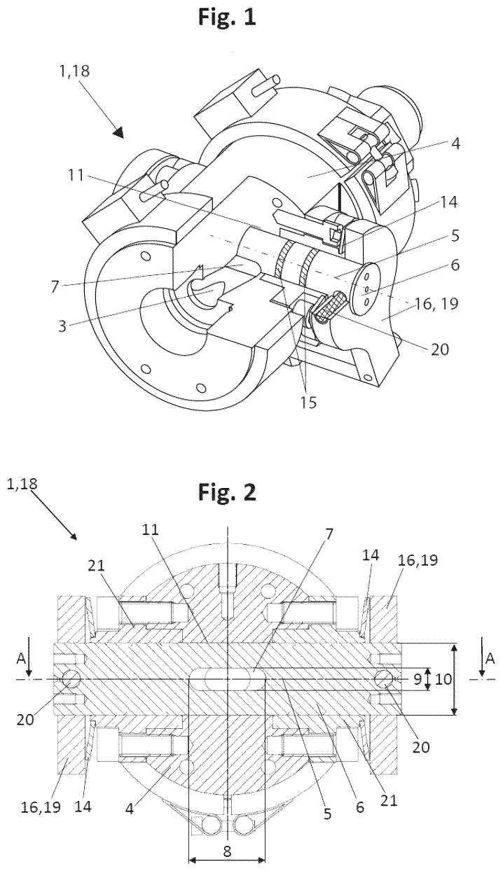

FIG. 1 is a perspective view of an exemplary embodiment according to the invention of a shut-off nozzle,

FIG. 2 is a section through the exemplary embodiment of FIG. 1 in a plane orthogonal to the longitudinal extension of the through-opening,

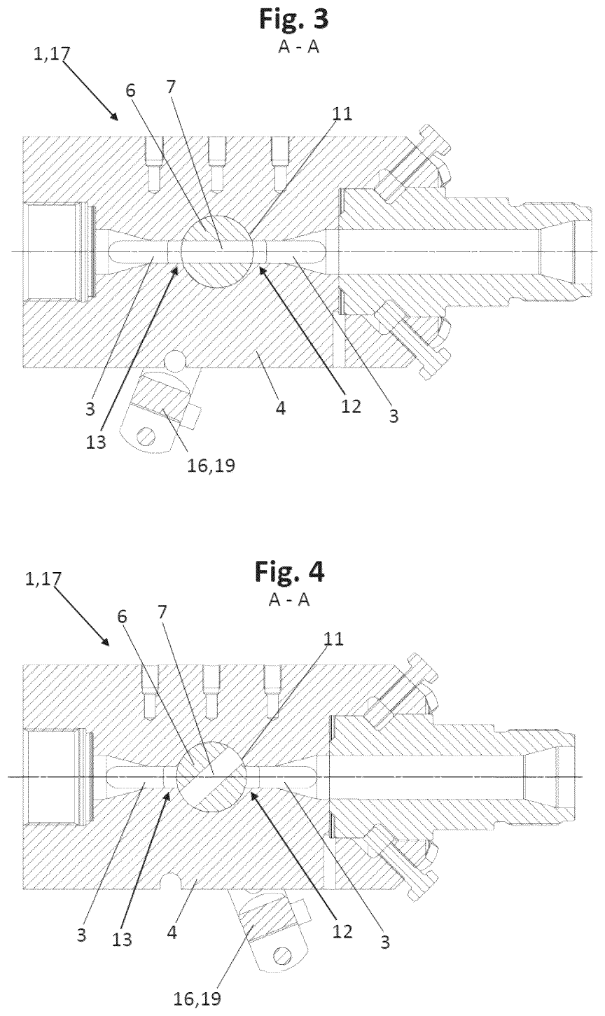

FIG. 3 is the section shown in FIG. 2 in a open position of the valve element,

FIG. 4 is the section shown in FIG. 2 in a closed position of the shut-off nozzle, and

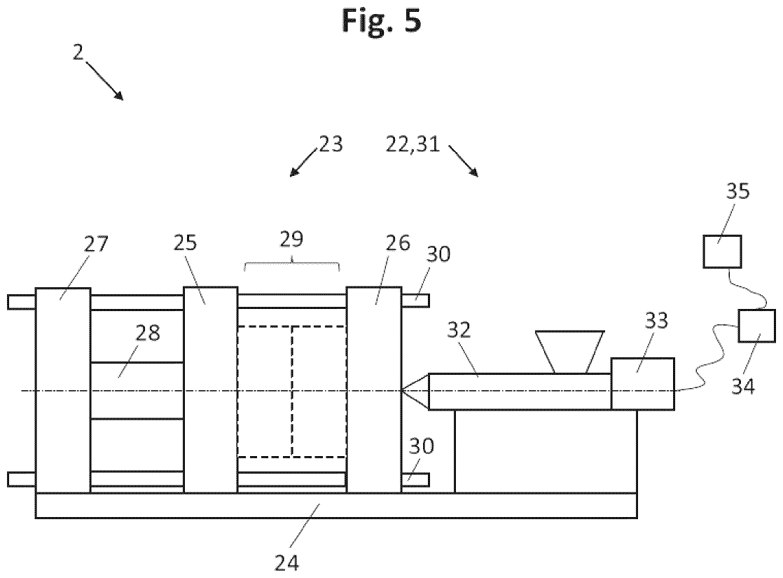

FIG. 5 is an exemplary embodiment of a molding machine.

FIG. 1 shows a perspective view of an exemplary embodiment according to the invention of a shut-off nozzle 1.

For a better illustration, a quarter of the shut-off nozzle 1 is cut out in the perspective view of FIG. 1, so that the inner components of the shut-off nozzle 1 are clearly visible.

FIG. 2 shows a sectional view through the exemplary embodiment of FIG. 1 through the shut-off nozzle, wherein the sectional plane was laid orthogonally to the longitudinal extent of the through-opening 7 of the valve element 6 (in an open position 18 of the valve element 6) and furthermore includes the axis of rotation 5 of the valve element 6.

FIGS. 3 and 4 represent sectional representations of the same exemplary embodiment of the shut-off nozzle 1, the sectional plane A-A of FIGS. 3 and 4 being identified in FIG. 2.

FIGS. 3 and 4 differ in that FIG. 3 represents an open position 18 of the shut-off nozzle 1 and FIG. 4 represents a closed position 17 of the shut-off nozzle 1.

It can be seen from FIGS. 1 to 4 that the shut-off nozzle 1 comprises a valve housing 4.

The valve housing 4 of this exemplary embodiment is formed by a central part of the valve housing 4 and by the bearing elements 21 which are screwed on.

A central fluid channel 3, which is designed to guide a fluid, preferably liquid and/or plastic fluid, passes through the valve housing 4.

Furthermore, the valve housing 4 comprises a recess 11 which passes through the valve housing 4 and which likewise passes through the fluid channel 3.

In this exemplary embodiment, this recess 11 is formed by a bore through the valve housing 4 and the bearing elements 21.

In the recess 11, the valve element 6 is arranged and mounted rotationally about the axis of rotation 5 in the valve housing 4.

In this exemplary embodiment, the valve element 6 is implemented as a bolt.

The valve element 6 has a through-opening 7 which, in the open position 18 of the shut-off nozzle 1, forms an extension of the fluid channel 3, so that the fluid can pass through the fluid channel 3 and the through-opening 7 through the shut-off nozzle 1 unhindered.

If a rotary movement of the valve element 6 about the axis of rotation 5 is carried out, the shut-off nozzle 1 can be transferred into a closed position 17, as shown, for example, by FIG. 4.

In this closed position 17, the fluid channel 3 is interrupted by the valve element 6, as a result of which a passage of a fluid through the shut-off nozzle 1 can be prevented.

It can be seen that a flow cross-section for a fluid between the fluid channel 3 and the through-opening 7 can be changed by the rotational movement of the valve element 6.

The valve element 6 is floatingly mounted in the valve housing 4.

This floating mounting of the valve element 6 in the valve housing 4 can be clearly seen in FIG. 2.

The valve element 6 is preloaded relative to the valve housing 4 via the disk springs 14.

These disk springs 14 are arranged between the valve housing 4 and the actuating elements 16 connected to the valve element 6 in a rotationally locked manner.

In this exemplary embodiment of the shut-off nozzle 1, the actuating elements 16 are implemented as part of the fork element 19 and are connected to the valve element 6 in a rotationally locked manner via the pins 20.

By actuating the fork element 19 at a lower articulation point, a rotational movement of the valve element 6 about the axis of rotation 5 can be implemented.

Such an actuation of the fork element 19 can take place, for example, via a linear drive.

By actuating and thus rotating the valve element 6 about the axis of rotation 5, the valve element 6 can be rotated between an open position 18 and a closed position 17.

The valve element 6 is sealed with respect to the valve housing 4 by means of the sealing elements 15.

Due to the floating mounting, the valve element 6 is allowed a certain free mobility along the axis of rotation 5, so that the valve element 6 with the through-opening 7 can align itself with respect to the fluid channel 3.

By virtue of this axial mobility of the valve element 6 relative to the valve housing 4, the valve element can be oriented by the flow of the fluid through the valve element 6 in such a way that the fluid channel 3 is aligned with the through-opening 7 at an inlet point 12 of the fluid channel 3 into the through-opening 7 and at the outlet point 13 of the through-opening 7 into the fluid channel 3.

This alignment thus prevents edges, steps or other disturbing influences on the flow of the fluid through the shut-off nozzle 1 and allows an optimum flow without turbulent flows forming, which can lead to excessive heating of the valve housing 4 or deposits in the fluid channel 3.

In order to reduce the construction size, it is provided in this exemplary embodiment that the through-opening 7 has a larger dimension 8 in a plane orthogonal to its longitudinal extent (as shown in FIG. 2) along the axis of rotation 5 than perpendicular thereto.

In other words, the through-opening 7 has a flat cross-sectional shape.

In this particular exemplary embodiment, the through-opening 7 is formed with a dimension 8 (see FIG. 2) parallel to the axis of rotation 5 larger than a height dimension 9 orthogonal thereto.

It can be recognized that this configuration of the through-opening 7 provides the largest possible flow cross-section, which nevertheless has little effect on the stability and the cross-section of the valve element 6 (with a relatively small diameter 10 of the valve element 6). In this exemplary embodiment of FIGS. 1 to 4, the ratio of the dimension 8 to the height dimension 9 is 2:1.

The dimension 8 of the through-opening 7 as implemented has substantially the same value as the diameter 10 of the valve element 6.

However, in order to be able to connect the shut-off nozzle 1 to a mold of the molding machine 2 and/or to an injection unit of the molding machine 2 without any problems, the fluid channel 3 transitions into a circular cross-section before the inlet point 12 and after the outlet point 12.

However, this transition and the circular cross-section of the shut-off nozzle 1 are designed in such a way that the cross-sectional area of the fluid channel 3 and of the through-opening 7 along their longitudinal extent through the shut-off nozzle 1 is constant in value, so that no cross-sectional taper or widening occurs when the fluid flows through the shut-off nozzle 1, so that no pressure variations or flow velocity changes occur during the passage of the fluid through the shut-off nozzle 1.

In the specific exemplary embodiment of the shut-off nozzle 1, the through-opening 7 is formed as an elongated hole in the valve element 6 which is constructed as a bolt.

The molding machine 2 shown as an example in FIG. 5 is an injection molding machine and has an injection unit 22 and a closing unit 23, which are arranged together on a machine frame 24. The machine frame 24 could alternatively be constructed in several parts.

The closing unit 23 has a fixed mold clamping plate 25, a movable mold clamping plate 26 and a front plate 27.

The movable mold clamping plate 26 is movable relative to the machine frame 24 via a symbolically represented toggle lever mechanism 28.

Mold halves of a mold 29 can be clamped or mounted on the fixed mold clamping plate 25 and the movable mold clamping plate 26 (shown in dashed lines).

The fixed mold clamping plate 25, the movable mold clamping plate 26 and the front plate 27 are supported and guided relative to one another by the spars 30.

The mold 29 shown closed in FIG. 5 has at least one cavity. An injection channel leads to the cavity, via which a plasticized mass of the plasticizing group 31 (for example via a shut-off nozzle 1 known from the preceding figures) can be supplied.

The injection unit 22 of this exemplary embodiment has a barrel 32 and a injection screw arranged in the barrel 32. This injection screw is rotatable about its longitudinal axis and is axially movable along the longitudinal axis in the conveying direction.

These movements are driven by a schematically shown drive unit 33. Preferably, this drive unit 33 comprises a rotary drive for the rotary movement and a linear drive for the axial injection movement.

FIG. 5 shows a molding machine 2 with an injection unit 22, wherein the injection unit 22 shown in this exemplary embodiment has an injection screw, which is also used for plasticizing a material to be plasticized.

The plasticizing group 31 (and thus the injection unit 22) is in signal connection with a control or regulating unit 34. The control or regulating unit 34 outputs control commands, for example, to the plasticizing group 31 and/or to the drive unit 33.

The control or regulating unit 34 can be connected to an operating unit and/or a display device 35 or can be an integral part of such an operating unit.

### LIST OF REFERENCE NUMERALS

1 shut-off nozzle
2 molding machine
3 fluid channel
4 valve housing
5 axis of rotation
6 valve element
7 through-opening
8 dimension
9 height dimension
10 diameter of the valve element
11 recess
12 inlet point
13 outlet point
14 disk spring
15 sealing element
16 actuating element
17 closed position
18 open position
19 fork element
20 pin
21 bearing element
22 injection unit
23 closing unit
24 machine frame
25 fixed mold clamping plate
26 movable mold clamping plate
27 front plate
28 toggle lever mechanism
29 mold
30 spar
31 plasticizing group
32 barrel
33 drive unit
34 control or regulation unit
35 operating unit and/or display device

1. A shut-off nozzle for a molding machine, comprising
a fluid housing having at least one fluid channel, wherein the at least one fluid channel is designed to guide a—preferably liquid and/or plastic—fluid and
a valve element which is mounted rotationally about an axis of rotation relative to the fluid housing and which passes through the fluid channel and has at least one through-opening for the passage of the fluid, wherein a flow cross-section between the fluid channel and the through-opening can be varied by a rotational movement of the valve element and thus a flow rate of the fluid can be influenced,
wherein the valve element is mounted in a floating manner in the valve housing along the axis of rotation.

2. The shut-off nozzle according to claim 1, wherein the valve element is arranged in a recess, preferably a bore, passing through the valve housing.

3. The shut-off nozzle according to claim 1, wherein the valve element is preloaded with respect to the valve housing by means of at least one spring element, preferably at least one disk spring.

4. The shut-off nozzle according to claim 2, wherein the valve element is preloaded at both ends of the recess passing through the valve housing by means of at least one spring element, preferably at least one disk spring.

5. The shut-off nozzle according to claim 1, wherein the valve element is sealed with respect to the valve housing by means of at least one sealing element, preferably at least one sealing ring.

6. The shut-off nozzle according to claim 1, wherein the valve element is connected in a rotationally movably locking manner to an actuating element, which actuating element is designed to rotate the valve element via a rotational movement between a closed position and an open position.

7. The shut-off nozzle according to claim 2, wherein the actuating element is designed as a fork element which is connected on both sides to the valve element passing through the valve housing in a rotational movably locked manner.

8. The shut-off nozzle according to claim 1, wherein the valve element is mounted with respect to the valve housing and/or with respect to a bearing element of the valve housing along the axis of rotation with a play of 0.01 mm to 5 mm, preferably 0.03 mm to 2.5 mm, particularly preferably 0.05 mm to 1 mm.

9. The shut-off nozzle according to claim 1, wherein the valve element is rotationally symmetrical, preferably in the form of a bolt.

10. The shut-off nozzle according to claim 1, wherein the at least one through-opening has a cross-section in a plane orthogonal to its longitudinal extent through the valve element, which cross-section has a larger dimension along the axis of rotation of the valve element than perpendicular thereto.

11. The shut-off nozzle according to claim 10, wherein the at least one through-opening is designed as an oblong hole in cross-section in the plane orthogonal to the longitudinal extent of the at least one through-opening.

12. The shut-off nozzle according to claim 10, wherein the ratio between the dimension of the at least one through-opening in cross-section in the plane orthogonal to the longitudinal extent of the at least one through-opening along the axis of rotation and a height dimension perpendicular thereto is at least 1.5:1, preferably 2:1.

13. The shut-off nozzle according to claim 10, wherein the value of the dimension of the at least one through-opening along the axis of rotation in cross-section in the plane orthogonal to the longitudinal extent of the at least one through-opening is in a range of plus/minus 20%, preferably plus/minus 10%, particularly preferably plus/minus 5%, of a diameter of the valve element in the region of the at least one through-opening.

14. The shut-off nozzle according to claim 1, wherein the at least one fluid channel of the valve housing has, in the flow direction of the fluid,
at an inlet point of the at least one fluid channel into the at least one through-opening of the valve element, and/or
at an outlet point of the at least one through-opening of the valve element into the at least one fluid channel,
the same cross-sectional shape as the at least one through-opening.

15. The shut-off nozzle according to claim 14, wherein the at least one fluid channel merges, preferably continuously, into a circular cross-section along its longitudinal extent before the inlet point into the at least one through-opening and/or after the outlet point from the at least one through-opening.

16. The shut-off nozzle according to claim 1, wherein the at least one fluid channel and/or the at least one through-opening have a value, preferably the same value, of a cross-sectional area along their longitudinal extent.

17. A molding machine and/or an injection unit for a molding machine, comprising a shut-off nozzle according to claim 1.
